(19) United States
(12) Patent Application Publication
(10) Pub. No.: US 2024/0198495 A1
(43) Pub. Date: Jun. 20, 2024

(54) ELECTRIC WRENCH WITH BUILT-IN BATTERY

(71) Applicant: BASSO INDUSTRY CORP., Taichung (TW)

(72) Inventors: Tian-Chi LAI, Taichung (TW); San-Yih SU, Taichung (TW); Yao-Sheng SHEN, Taichung (TW)

(73) Assignee: BASSO INDUSTRY CORP., Taichung (TW)

(21) Appl. No.: 18/537,352

(22) Filed: Dec. 12, 2023

(30) Foreign Application Priority Data
Dec. 15, 2022 (TW) 111148309

(51) Int. Cl. B25B 13/00; B25B 21/00

(52) U.S. Cl. CPC B25B 13/00; B25B 21/002; B25B 21/007

(57) ABSTRACT

An electric wrench includes a tool head unit, a wrench body unit that defines an accommodating space extending along a first axis, an output unit that includes a head driver configured to rotate in a selected direction and output rotational energy, a handle unit, an electric unit that is operable for driving rotation of the head driver, and a control unit that is mounted on the wrench body unit. The control unit includes a display, a control module that is disposed in the accommodating space, and a battery module that is disposed in the accommodating space between the electric unit and the handle unit, and that has at least one battery configured to provide electric energy to the electric unit and the display. The electric unit, the battery module and the handle unit are arranged along the first axis.

### CROSS-REFERENCE TO RELATED APPLICATION

This application claims priority to Taiwanese Invention Patent Application No. 111148309, filed on Dec. 15, 2022, the entire disclosure of which is incorporated by reference herein.

### FIELD

The disclosure relates to an electric wrench, and more particularly to an electric wrench with built-in battery.

### BACKGROUND

A conventional electric wrench is electrically powered to fasten screws or nuts, and derives its popular appeal from the labor-saving advantage that it provides. However, a torque force outputted by the conventional electric wrench is limited by the electric power that can be supplied to it; thus, in situations where electric power cannot be supplied or the torque requirements of the task at hand exceed the output range of the conventional electric wrench, most commercially available conventional electric wrenches, in addition to allowing electrically powered operation, also allow manual operation.

Referring to FIG. 1, a conventional electric wrench 1 as disclosed in US Patent Publication No. 20220266439 includes a tool head portion 11 connected to a main body (not shown), an output member 12 mounted to the tool head portion 11 and configured to output rotational energy, a frame 13 mounted to the main body, a motor 14 mounted on the frame 13 and operable for driving rotation of the output member 12, a battery cell 15 mounted on the frame 13 for providing electric power to the motor 14, and a charging connector 16 electrically connected to the battery cell 15.

However, because the battery cell 15 is disposed near a distal end of the main body and is proximate to a portion for gripping the conventional electric wrench 1, the battery cell 15 and the charging connector 16 directly receive external forces that may damage or cause the circuits to detach, thereby lowering the reliability of the conventional electric wrench 1.

### SUMMARY

Therefore, an object of the disclosure is to provide an electric wrench that can alleviate at least one of the drawbacks of the prior art.

According to the disclosure, the electric wrench includes a tool head unit, a wrench body unit, an output unit, a handle unit, an electric unit, and a control unit. The wrench body unit is connected to the tool head unit, and defines an accommodating space that extends along a first axis. The output unit includes a head driver that is mounted to the tool head unit, that extends along a second axis being transverse to the first axis, and that is configured to rotate in a selected direction and output rotational energy. The handle unit is connected to the wrench body unit and is opposite to the tool head unit along the first axis. The electric unit is mounted in the accommodating space, is proximate to the tool head unit, and is operable for driving rotation of the head driver. The control unit is mounted on the wrench body unit, and includes a display that is configured to display an output value, a control module that is disposed in the accommodating space and that is signally connected to the electric unit and the display, and a battery module that is disposed in the accommodating space between the electric unit and the handle unit, and that is electrically connected to the control module. The battery module has at least one battery configured to provide electric energy to the electric unit and the display. The electric unit, the battery module and the handle unit are arranged along the first axis.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmented side view of a conventional electric wrench disclosed in US Patent Publication No. 20220266439.

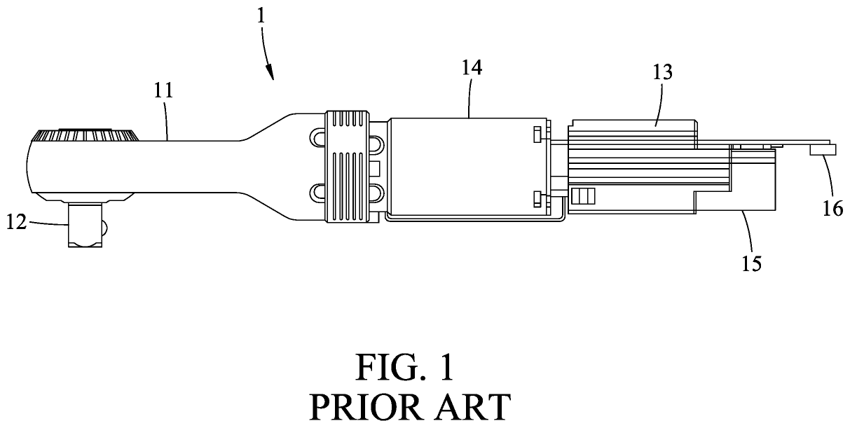

FIG. 2 is an exploded perspective view illustrating an embodiment of an electric wrench according to the disclosure.

FIG. 3 is a top view of the embodiment.

FIG. 4 is a sectional view of the embodiment taken along line IV-IV in FIG. 3.

FIG. 5 is a fragmentary sectional view of the embodiment taken along line V-V in FIG. 4.

FIG. 6 is a view that is similar to FIG. 5, but with a transmitting handle that is moved relative to a tail portion of a shell member of a wrench body unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

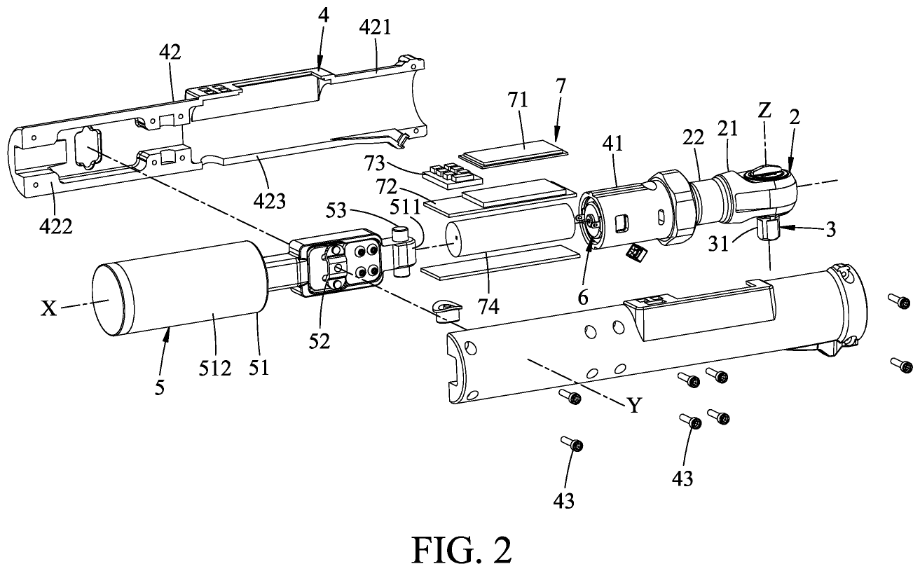

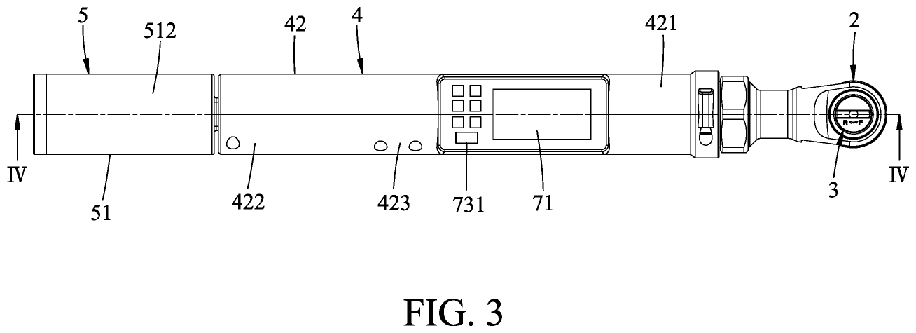

Referring to FIGS. 2 to 3, an embodiment of an electric wrench according to the present disclosure includes a tool head unit 2, an output unit 3, a wrench body unit 4, a handle unit 5, an electric unit 6, and a control unit 7.

In this embodiment, the tool head unit 2 includes an H-section 21 and a neck 22 that is connected to the H-section 21, and that extends along a first axis (X).

Referring to FIGS. 2, 4 and 5, the output unit 3 includes a head driver 31, and a yoke 32.

The head driver 31 is mounted to the H-section 21 of the tool head unit 2, extends along a second axis (Z) transverse to the first axis (X), and is configured to rotate in a selected direction and output rotational energy. It should be noted that in this embodiment, the second axis (Z) is substantially perpendicular to the first axis (X).

The yoke 32 includes an annular toothed portion 321 that surrounds the head driver 31, and an activated portion 322 that is disposed in the neck 22.

The output unit 3 is known in the prior art and is not a distinctive feature of the disclosure; hence, it will not be described in further detail.

The wrench body unit 4 is connected to the tool head unit 2, and defines an accommodating space 40 that extends along the first axis (X). More specifically, the wrench body unit 4 includes a first shell member 41 connected to the neck 22 of the tool head unit 2, a second shell member 42 sleeved on the first shell member 41, and a plurality of fastening members 43. In this embodiment, the second shell member 42 is composed of two parts that are coupled together and that are fastened together by the fastening members 43. The second shell member 42 has a head portion 421 that surrounds the first shell portion 41, a tail portion 422 that is connected to the handle unit 5, that is disposed opposite to the head portion 421, and that defines a passage 420 extending along the first axis (X), and an intermediate portion 423 that is connected between the head portion 421 and the tail portion 422, and that cooperates with the first shell member 41 to define the accommodating space 40 that extends along the first axis (X).

Referring to FIGS. 2, 5 and 6, the handle unit 5 is connected to the wrench body unit 4 and is opposite to the tool head unit 2 along the first axis (X). More specifically, the handle unit 5 includes a transmitting handle 51 pivotably connected to the tail portion 422, and at least one sensor module 52 mounted between the tail portion 422 and the transmitting handle 51. In this embodiment, the at least one sensor module 52 includes two sensor modules 52.

In this embodiment, the transmitting handle 51 has a connecting portion 511 that is disposed in the passage 420 and that is pivotably connected to the tail portion 422 of the second shell member 42, and a grip portion 512 that is opposite to the connecting portion 511 and that is disposed outside of the tail portion 422. The connecting portion 511 extends along the first axis (X), overlaps with the tail portion 422 of the wrench body unit 4, and has two installation surfaces 513 that are spaced apart along a third axis (Y) that is substantially perpendicular to the first axis (X) and the second axis (Z).

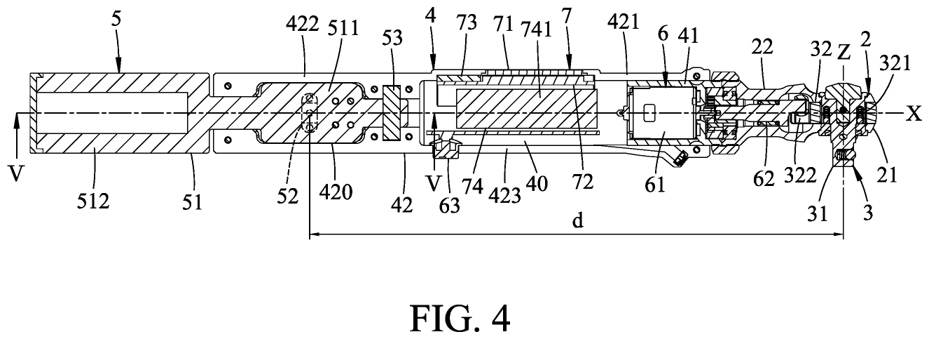

The two sensor modules 52 are disposed between the connecting portion 511 and the tail portion 422 of the second shell member 42, and are configured to output a torque reading of a force (F). Specifically, the sensor modules 52 are mounted respectively on the installation surfaces 513 of the connecting portion 511 of the transmitting handle 51 and are spaced apart along the third axis (Y). More specifically, when the transmitting handle 51 is driven by a force (F) to pivot relative to the tail portion 422, the sensor modules 52 output a torque reading of the force (F). In this embodiment, the two sensor modules 52 are load cells (not shown), and are operable for sensing the force (F). Referring further to FIG. 4, a length of a torque arm (d) is defined by the distance along the first axis (X) between the sensor modules 52 and the rotational axis of the head driver 31 (i.e., the first axis (X)).

The handle unit 5 further includes a shaft member 53. The shaft member 53 extends in a direction of the second axis (Z) through the connecting portion 511 of the transmitting handle 51, is rotatably disposed in the tail portion 422, and is configured for allowing the transmitting handle 5 to pivot relative to the tail portion 422.

The electric unit 6 is mounted in the accommodating space 40, is proximate to the tool head unit 2, and is operable for driving rotation of the head driver 31. More specifically, the electric unit 6 includes an electric motor 61 that is mounted in the first shell member 41 and in the accommodating space 40, and that is operable for converting electric energy to kinetic energy, a transmission subunit 62 that is disposed between the head driver 31 and the electric motor 61, and that is configured to transmit kinetic energy to the head driver 31, and an activation button 63 that is disposed on the intermediate portion 423 of the second shell member 42, that is proximate to the tail portion 422, and that is operable for outputting an activation signal for activating the electric motor 61.

Referring to FIGS. 2, 4 and 5, the control unit 7 is mounted on the wrench body unit 4, and includes a display 71, a control module 72, a connection port module 73, and a battery module 74.

The display 71 is installed in the intermediate portion 423 of the second shell member 42, is exposed from an outer surface of the intermediate portion 423, and is configured to display an output value.

The control module 72 is installed in the intermediate portion 423 and disposed in the accommodating space 40. The control module 72 is signally connected to the electric unit 6, the display 71, and the sensor modules 52, and is configured to activate the electric motor 61 upon receiving the activation signal from the activation button 63. The control module 72 calculates the output value of a torque of the driving head 31 according to a moment arm formula, and the display 71 displays the output value. The moment arm formula states: torque (L)=torque arm (d)×force (F).

The connection port module 73 is disposed in the intermediate portion 423, is adjacent to the display 71, is electronically connected to the control module 72, and has a connection port 731 (see FIG. 3) adapted to be connected to a power source (not shown).

The battery module 74 is installed in the intermediate portion 423, is disposed in the accommodation space 40 between the electric unit 6 and the handle unit 5, is electrically connected to the control module 72, and has at least one battery 741 configured to provide electric energy to the electric unit 6 and the display 71. Specifically, the electric unit 6, the battery module 74 and the handle unit 5 are arranged along the first axis (X). In this embodiment, the battery 741 is a rechargeable lithium-ion battery, and is configured to store electric energy from an external power source or utility power delivered through the connection port 731.

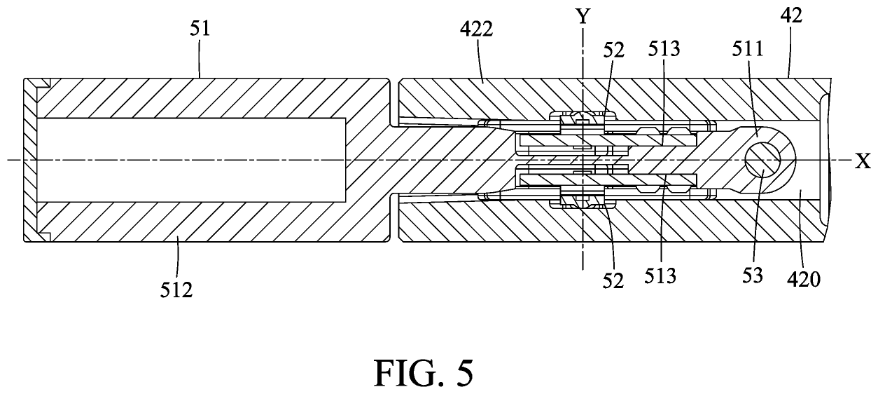

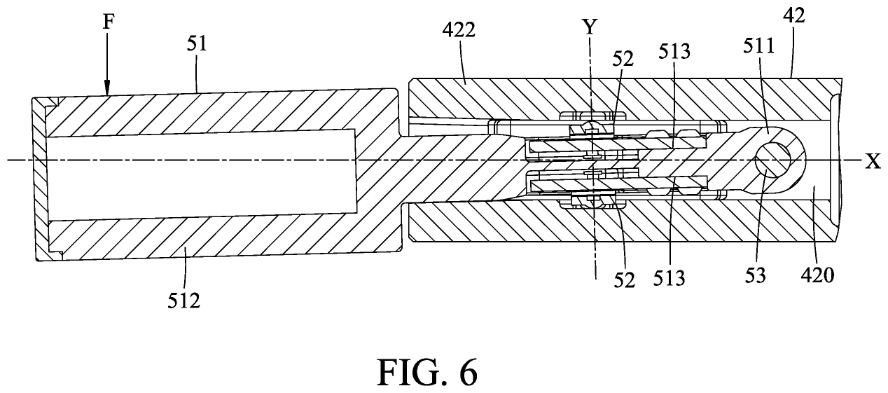

Referring to FIGS. 5 and 6, when a user grips the transmitting handle 51 and activates the electric motor 61 by pressing the activation button 63, kinetic energy from the electric motor 61 is transmitted by the transmission subunit 62 which drives the activated portion 322 of the yoke 32 to pivot, and drives the head driver 31 to rotate about the second axis (Z), thereby allowing the electric wrench to fasten or loosen a screw or nut (not shown).

When the embodiment of the electric wrench is operated manually, a force (F) is exerted by the user on the transmitting handle 51, the tool head unit 2, the wrench body unit 4 and the handle unit 5 will act collectively as a single torque arm to transmit rotational power which drives the head driver 31 to rotate, thereby allowing the electric wrench to fasten or loosen a screw or nut (not shown).

Specifically, when driven by the force (F), the transmitting handle 51 pivots around the shaft member 53 relative to the tail portion 422 along a direction of the force (F); during this process, a respective one of the two sensor modules 52 will be compressed (FIG. 6) and will output a torque value. Hence, it is possible to calculate the torque value of the head driver 31 through the moment arm formula since the torque arm (d) is already known, and the torque value may be displayed by the display 71. It should be noted that, when the embodiment of the electric wrench is operated manually, the electric motor 61 is inactive; and the displayed torque value is a corrected value of the calculated torque value that has been corrected by a correction factor.

Furthermore, the two sensor modules 52 are not limited to load cells, in other variants of the embodiment, the two sensor modules 52 may be strain gauges. When an external force is exerted on the tail portion 422, the deformation of the tail portion 422 will be detected by the two sensor modules 52 as a change in electric resistance thereof and will be outputted as a sensor value; the torque value is calculated in accordance to the sensor value and then displayed on the display 71.

It should be noted that the neck 22 and the first shell member 41 is not limited to being composed of two separate components; in other variants of the embodiment, the first shell member 41 may be integrally formed with the neck 22, and extend along the first axis (X) to accommodate the electric motor 61.

In conclusion, the advantages of the embodiment are as follows:

The accommodation space 40 that is cooperatively defined by the intermediate portion 423 of the second shell member 42 and the first shell member 41 allows the battery module 74, the connection port module 73, and the control module 72 to be distanced away from the tail portion 422 and the transmitting handle 51 where the force (F) is exerted, so that the battery module 74 is not directly affected or compressed during operation, thereby increasing the reliability of the control unit 7; furthermore, the sensitivity of the sensor is greatly improved by the sensor module 52 being proximate to the transmitting handle 51.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric wrench comprising:
a tool head unit;
a wrench body unit connected to said tool head unit, and defining an accommodating space that extends along a first axis;
an output unit including a head driver that is mounted to said tool head unit, that extends along a second axis being transverse to the first axis, and that is configured to rotate in a selected direction and output rotational energy;
a handle unit connected to said wrench body unit and being opposite to said tool head unit along the first axis;
an electric unit mounted in said accommodating space, being proximate to said tool head unit, and operable for driving rotation of said head driver; and
a control unit mounted on said wrench body unit, and including
a display that is configured to display an output value,
a control module that is disposed in said accommodating space and that is signally connected to said electric unit and said display, and
a battery module that is disposed in said accommodating space between said electric unit and said handle unit, that is electrically connected to said control module, and that has at least one battery configured to provide electric energy to said electric unit and said display;
wherein said electric unit, said battery module and said handle unit are arranged along the first axis.

2. The electric wrench as claimed in claim 1, wherein said wrench body unit includes:
a first shell member connected to said tool head unit; and
a second shell member sleeved on said first shell member.

3. The electric wrench as claimed in claim 2, wherein said electric unit includes:
an electric motor mounted in said first shell member and operable for converting electric energy to kinetic energy; and
a transmission subunit disposed between said head driver and said electric motor, and being configured to transmit kinetic energy to said head driver.

4. The electric wrench as claimed in claim 2, wherein:
said second shell member has
a head portion surrounding said first shell member,
a tail portion connected to said handle unit, and
an intermediate portion connected between said head portion and said tail portion, and cooperating with said first shell member to define said accommodating space; and
said display, said control module, and said battery module are installed in said intermediate portion.

5. The electric wrench as claimed in claim 4, wherein:
said control unit further includes a connection port module that is disposed in said intermediate portion, that is electronically connected to said control module, and that has a connection port adapted to be connected to a power source.

6. The electric wrench as claimed in claim 4, wherein:
said handle unit includes
a transmitting handle pivotably connected to said tail portion, and
at least one sensor module mounted between said tail portion and said transmitting handle, and is signally connected to said control module; and
when said transmitting handle is driven by a force to pivot relative to said tail portion, said at least one sensor module outputs a torque reading of the force.

7. The electric wrench as claimed in claim 6, wherein:
said tail portion of said second shell member defines a passage extending along the first axis;
said transmitting handle has
a connecting portion disposed in said passage, and pivotably connected to said tail portion of said second shell member, and
a grip portion being opposite to said connecting portion, and disposed outside of said tail portion; and
said at least one sensor module is disposed between said connecting portion of said transmitting handle and said tail portion of said second shell member.

8. The electric wrench as claimed in claim 7, wherein:
the first axis is substantially perpendicular to the second axis; and
said at least one sensor module includes two sensor modules mounted on said connecting portion of said transmitting handle and being spaced apart along a third axis that is substantially perpendicular to the first axis and the second axis.

9. The electric wrench as claimed in claim 6, wherein said at least one sensor module is at least one load cell.

10. The electric wrench as claimed in claim 6, wherein said at least one sensor module is at least one strain gauge.

11. The electric wrench as claimed in claim 1, wherein said handle unit includes:
a transmitting handle connected to said wrench body unit, and having a portion that overlaps said wrench body unit along the first axis; and
at least one sensor module disposed between said portion of said transmitting handle and said wrench body unit, signally connected to said control module, and configured to output a torque reading of a force that is exerted on said transmitting handle.

12. The electric wrench as claimed in claim 11, wherein said at least one sensor module is at least one load cell.

13. The electric wrench as claimed in claim 11, wherein said at least one sensor module is at least one strain gauge.
